(19) United States
(12) Patent Application Publication
(10) Pub. No.: US 2026/0318363 A1
(43) Pub. Date: Oct. 15, 2026

(54) SYSTEM FOR COUPLING TWO AIRCRAFT TURBINE ENGINE PARTS, PREFERABLY TWO TURBINE ENGINE SHAFTS

(71) Applicant: SAFRAN AIRCRAFT ENGINES, Paris (FR)

(72) Inventors: Thomas Jérôme George DUNOYER DE SEGONZAC, Moissy-Cramayel (FR); Vianney SIMON, Moissy-Cramayel (FR); Patrice Jean-Marc ROSSET, Moissy-Cramayel (FR); Thierry FACHAT, Moissy-Cramayel (FR); Patrick Jean Laurent SULTANA, Moissy-Cramayel (FR)

(73) Assignee: SAFRAN AIRCRAFT ENGINES, Paris (FR)

(21) Appl. No.: 19/483,693

(22) PCT Filed: Jul. 23, 2024
(86) PCT No.: PCT/FR2024/051016

§ 371 Date: Nov. 12, 2025

(30) Foreign Application Priority Data
Jul. 26, 2023 (FR) FR2308059

(51) Int. Cl. F16D 1/108; F01D 25/00; F16D 1/10

(52) U.S. Cl. CPC F16D 1/108; F01D 25/00; F05D 2240/60; F16D 2001/103

(57) ABSTRACT

A system for coupling two aircraft turbine engine parts, the system including a nut for clamping the two parts together, and an anti-rotation ring that includes a first rotational coupling member intended to cooperate with a first complementary rotational coupling member provided on the first part, so as to form a first rotational coupling device; a second rotational coupling member intended to cooperate with a second complementary rotational coupling member provided on the nut, so as to form a second rotational coupling device. The coupling system is configured such that the ring can be placed in a provisional axial position relative to the nut and then be moved into a final coupling axial position.

### TECHNICAL FIELD

The invention relates to the field of systems for coupling two parts of an aircraft turbine engine, for example such as a turbojet or a turboprop.

Preferably, the invention relates to a system for coupling two shafts of the aircraft turbine engine, for example a compressor shaft and a turbine shaft, but it is not limited to this preferred use.

Another use of the invention lies for example in the coupling of a bearing onto a turbine engine shaft.

### PRIOR ART

Systems for coupling aircraft turbine engine parts have been broadly developed in the prior art. An example of a coupling system is disclosed in the document FR 2 858 249 A1.

In some turbine engine architectures, such a coupling system can comprise a nut for clamping the two parts together, the nut thus being provided with a thread cooperating with another thread made on one of the two parts to be coupled. The coupling system further comprises an anti-rotation ring cooperating with the nut, this ring being intended to limit/prevent the rotation of this nut relative to the aforementioned part.

The method for mounting such a system generally requires tightening the nut until a minimum tightening is achieved, to carry out the coupling between the two parts. Then, an additional tightening of the nut, called over-torque, is carried out only for the purpose of placing the various means allowing the anti-rotation function of the nut in a matching position.

Usually, the means allowing the anti-rotation function comprise on the shaft either notches involving significant over-torques to be applied during the assembly, or particularly expensive splines.

Previous embodiments of this type can prove problematic, firstly because the over-torque applied to the nut introduces undesirable mechanical stresses in the assembly. To limit these stresses, it is possible to increase the pitch/the fineness of the anti-rotation means, like the aforementioned splines, but this strategy inevitably leads to additional manufacturing costs.

Furthermore, the previous embodiments can have designs that require visual access for the mounting of the coupling system. However, this visual access is not always possible in the dense environment of a turbine engine.

There is therefore a need to improve the design of the coupling systems of the prior art.

### DISCLOSURE OF THE INVENTION

To meet the need mentioned above, the object of the invention is first of all a system for coupling two aircraft turbine engine parts, according to the features of claim 1.

Via this design, the possible over-torque to be applied to the nut during the assembly remains advantageously moderate, so that the assembly is less mechanically stressed, without however needing to increase the pitch/the fineness of the anti-rotation means, like splines and/or finger-notch assemblies.

Moreover, the design of the invention is also advantageous in that it allows blind mounting of the coupling system, that is to say without visual access to the zone of the turbine engine in which the mounting is carried out. This situation occurs in particular during the coupling of parts having large diameters, like turbine engine shafts, and the invention thus proves to be particularly suitable for this use.

The invention preferably comprises at least any one of the following optional features, taken alone or in combination.

Preferably, the first rotational coupling device comprises, and preferably consists of one or more finger-notch assemblies, the number of these assemblies being preferably less than six, and even more preferably less than four. The reduced number of these finger-notch assemblies, to stop the first turbine engine part from rotating via the ring, greatly reduces the manufacturing costs, in particular relative to a splined solution, which is nevertheless possible.

Preferably, the second rotational coupling device is formed by splines, to stop the nut from rotating, via the ring. Such splines remain less expensive to produce on these elements than on the parts to be coupled, like turbine engine shafts.

In this embodiment, it is therefore the finger-notch assemblies forming the first coupling device that are first engaged, and then it is the splines forming the second coupling device that are engaged after being placed in a matching position. Since the pitch of the splines is smaller than that of the notches, the rotation of the nut to be applied to allow the desired matching position, and the possible over-torque that results therefrom, remain advantageously small.

Preferably, in the provisional axial position of the ring, said first coupling member and said first complementary coupling member are intended to create a circumferential clearance between them allowing, by this clearance being used up, sufficient angular displacement of the ring to allow said second coupling member to be placed, in the circumferential direction, in a position matching said second complementary coupling member, this matching position allowing the axial movement of the anti-rotation ring from its provisional axial position to its final coupling axial position.

In this solution, it is effectively the aforementioned clearance being used up that allows, where applicable, to place the second coupling member(s) in a position matching the second complementary coupling member(s). Consequently, advantageously, no over-torque on the nut is required to finalize the mounting of the coupling system.

It is noted that another solution without clearance could involve applying a moderate over-torque to the nut, to finalize the mounting. A hybrid solution is also conceivable, wherein the finalization of the mounting of the coupling system can require the clearance to be used up, and the application of an over-torque to the nut, with an even further reduced intensity. Preferably, the coupling system comprises elastic return means arranged between the nut and the anti-rotation ring, so as to force the latter axially towards its final coupling axial position. This design proves to be particularly indicated when there is no visual access to the mounting zone. It automatically engenders the axial movements required for the anti-rotation ring. These elastic return means also allow, preferably, to maintain the anti-rotation ring in the final mounting position, even if other means can be adopted to carry out the latter function, without going beyond the scope of the invention.

Preferably, said first coupling member and said first complementary coupling member have inclined circumferential stop surfaces, forming an angle with respect to the axial direction. With this design, it is possible to have a circumferential clearance between the first coupling member and the first complementary coupling member, in an intermediate axial position of the ring. Then, once the second coupling member and the second complementary coupling member have been placed in a matching position, for example by partially using up this circumferential clearance, the ring can be axially moved by the elastic return means, until its final coupling position in which the inclined circumferential stop surfaces are in contact two by two.

Preferably, the nut and the anti-rotation ring are concentric, the anti-rotation ring being inserted inside the nut.

The object of the invention is also an assembly for an aircraft turbine engine comprising two parts, as well as a system as described above, coupling the two parts which are preferably two turbine engine shafts. Nonetheless, other uses are possible, without going beyond the scope of the invention.

The object of the invention is also an aircraft turbine engine comprising at least one such assembly. For example, this can be a turbojet or a turboprop.

Finally, the object of the invention is also a method for mounting a coupling system as described above, on two parts of an aircraft turbine engine to be coupled, comprising the following steps:
carrying out a tightening of the nut on the first part, via the nut and first part threads, so as to axially press the first part against the second part;
bringing the anti-rotation ring into its provisional axial position relative to the nut, so as to place the first rotational coupling device in its coupling configuration, while keeping the second rotational coupling device in its non-coupling configuration;
moving the anti-rotation ring relative to the nut, from its provisional axial position to its final coupling axial position after rotation of the ring relative to the nut, so as to bring the second rotational coupling device into its coupling configuration, while keeping the first rotational coupling system in its coupling configuration.

Other advantages and features of the invention will appear in the non-limiting detailed description below.

### BRIEF DESCRIPTION OF THE DRAWINGS

FIG. 1 is a longitudinal cross-sectional view of a turbojet;

FIG. 2 is a longitudinal half-section view of a system for coupling two parts of the turbojet shown in the preceding figure;

FIG. 3 is a transverse cross-sectional view of the coupling system shown in FIG. 2, and corresponding to the cross-section taken along the line III-III of FIG. 2;

FIG. 4 is a partial perspective view of a clamping nut of the coupling system shown in FIGS. 2 and 3;

FIG. 5 is a partial perspective view of an anti-rotation ring of the coupling system shown in FIGS. 2 and 3;

FIG. 6 is a partial perspective view of an anti-rotation ring, according to one alternative;

FIG. 7 is a partial perspective view of an end of a shaft of the turbine engine, intended to be coupled by the coupling system shown in FIGS. 2 and 3;

FIG. 8 is a partial perspective view of the coupling system shown in FIGS. 2 and 3;

FIG. 9

FIG. 10

FIG. 12 are longitudinal half-section views of the coupling system shown in FIG. 2, in various successive states during a method for mounting this coupling system;

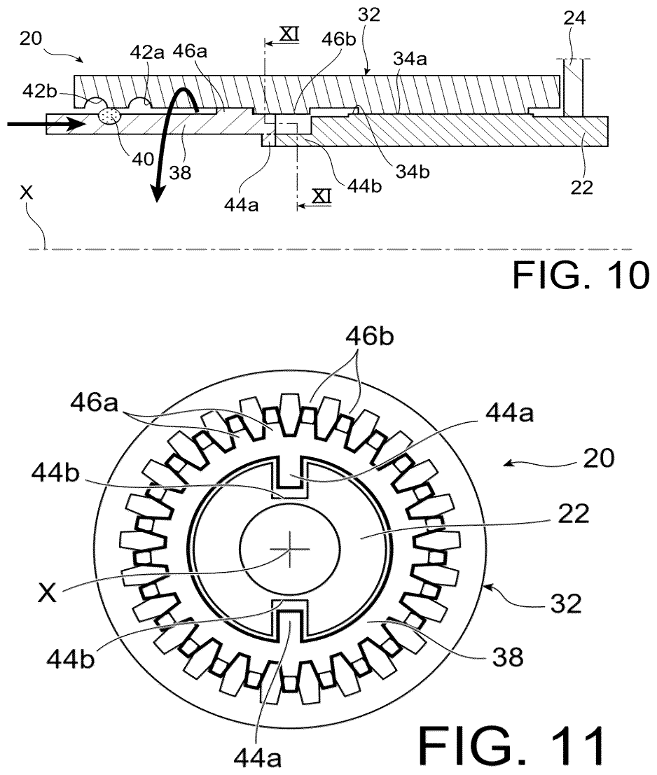

FIG. 11 is a transverse cross-sectional view of the coupling system shown in FIG. 10, and corresponding to the cross-section taken along the line XI-XI of FIG. 10;

FIG. 13

FIG. 14 are transverse cross-sectional views of the coupling system shown in the preceding figures, according to one alternative, and in various successive states during the method for mounting this coupling system;

FIG. 15 is a longitudinal half-section view of the coupling system analogous to that shown in the preceding figures, and presented in the form of an alternative;

FIG. 16

FIG. 17

FIG. 18

FIG. 19 are partial cross-sectional views of the coupling system according to yet another alternative, in various successive states during the method for mounting this coupling system;

FIG. 20 is a partial perspective view of a system for locking a plug in a part of the turbojet, this locking system being integrated into the coupling system shown in the preceding figures;

FIG. 21 is an axial view of the plug shown in the preceding figure;

FIG. 22

FIG. 23

FIG. 24 are partial perspective views of the locking system shown in FIG. 20, in various successive states during a method for mounting this locking system;

FIG. 25 is a partial cross-sectional view of the locking system, in its state as shown in FIG. 23;

FIG. 26 is a partial cross-sectional view of the locking system, in its state as shown in FIG. 24;

FIG. 27 is a partial cross-sectional view of the locking system, in its state at the end of the method for mounting this system.

### DETAILED DESCRIPTION OF THE INVENTION

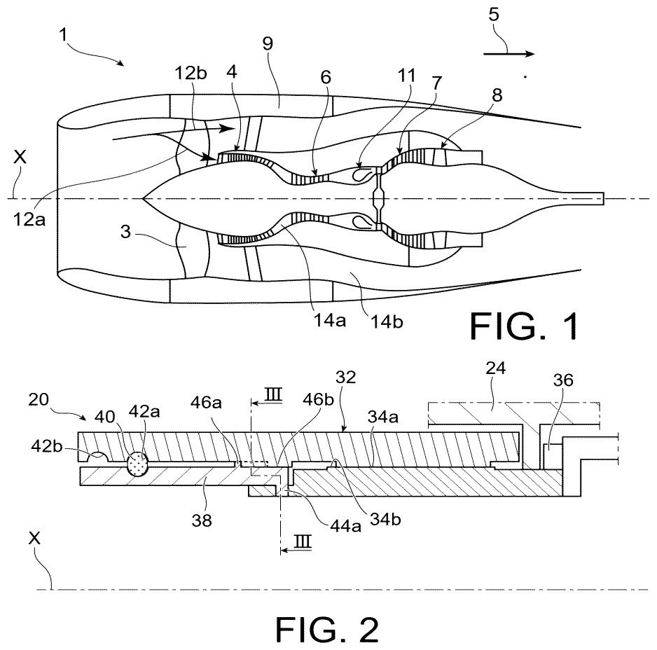

In reference first of all to FIG. 1, an aircraft turbine engine 1 is shown, according to a preferred embodiment of the invention. Here, this is a two-spool turbofan. Nevertheless, this could be a turbine engine of another type, for example a turboprop, without going beyond the scope of the invention.

The turbine engine 1 has an axis X around which its various components extend, this axis being called longitudinal axis of the turbine engine. It comprises, from upstream to downstream in a main direction 5 of flow of the gases through this turbine engine, a fan 3, a low-pressure compressor 4, a high-pressure compressor 6, a combustion chamber 11, a high-pressure turbine 7 and a low-pressure turbine 8.

Conventionally, after passing through the fan, the air is divided into a central primary flow 12a and a bypass flow 12b that surrounds the primary flow. The primary flow 12a flows in a main duct 14a of circulation of the gases passing through the compressors 4, 6, the combustion chamber 11 and the turbines 7, 8. As for the bypass flow 12b, it flows in a bypass duct 14b defined radially towards the outside by an engine casing, surrounded by a nacelle 9.

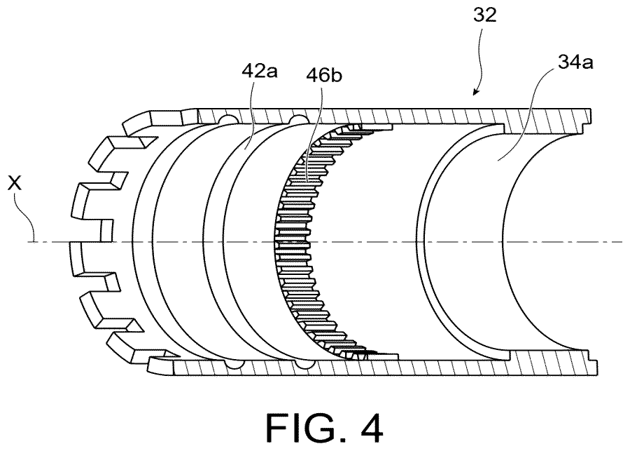

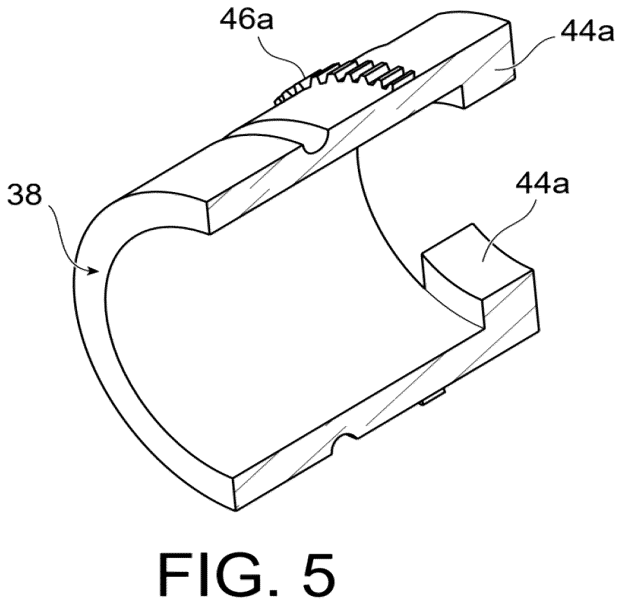

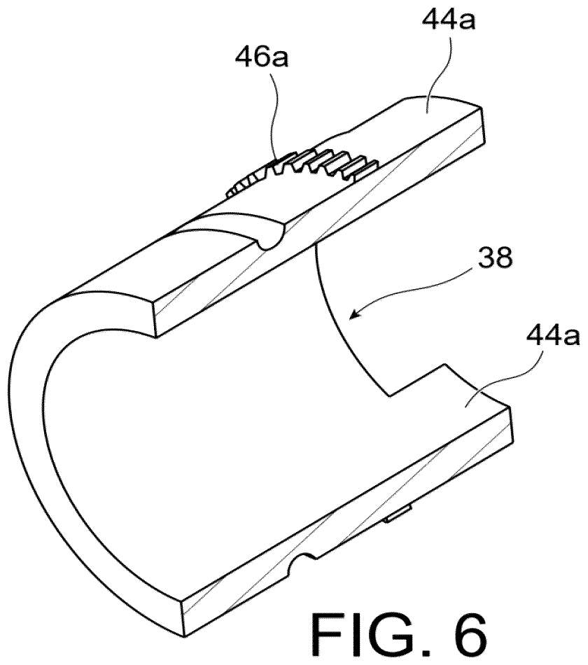

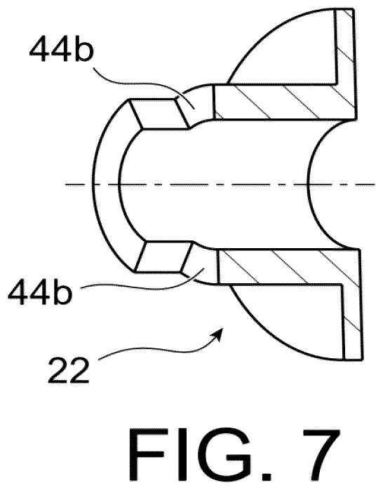

FIGS. 2 to 8 show a system 20 for coupling two rotary parts of the turbojet 1, having the same axis of rotation X. Here, these are a first shaft 22 corresponding to a shaft of the low-pressure turbine, and a second shaft 24 corresponding to a shaft of the low-pressure compressor. These two shafts 22, 24 are hollow, and the upstream end of the first shaft 22 is inserted into the downstream end of the second shaft 24, so as to be coupled in translation and rotation according to the axial direction, via the system 20. The two shafts 22, 24, concentric and centered on the axis X, form an assembly 30 with their coupling system 20. Several assemblies of this type can be provided in the turbojet, with coupled parts that can indifferently belong to various modules of the turbojet, including the fan, the compressors, the combustion chamber, or the turbines.

The coupling of parts having large diameters, and the visual access to the coupling zone of which proves to be limited or even null, is preferred here. This is in particular the case for the architecture shown partially in FIG. 2, showing the system 20 in a mounted state, in which the two shafts 22, 24 are coupled.

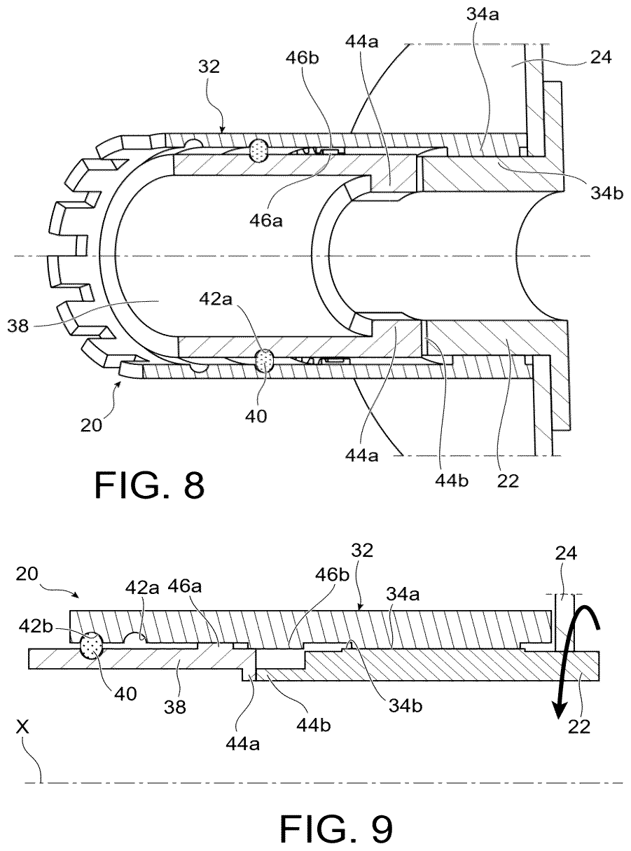

The coupling system 20 first comprises a nut 32 for clamping the two shafts, this nut being centered on the axis X and provided with a first thread 34a, or nut thread, cooperating with a second thread 34b, or first part thread, made on an outer surface of the first shaft 22. As visible in FIGS. 2 and 8, in the mounted state of the coupling system 20, the downstream end of the nut 32 exerts an axial force on the second shaft 24, and more precisely on an inner shoulder thereof. This axial force pushes the second shaft 34 downstream against an outer shoulder of the first shaft 22, with an axial shim 36 optionally interposed between the two shoulders, as shown as an example in FIG. 2. The intensity of axial tightening of the nut is sufficient to generate the desired coupling between the two shafts 22, 24.

The system 20 also comprises an anti-rotation ring 38 intended to limit/prevent the rotation of the nut 32, relative to the first shaft 22, in the mounted state of the system 20. The anti-rotation ring 38 is centered on the axis X, while being arranged at least partly internally in the nut 32, and while being capable of being moved axially relative to the latter, in various axial positions. In FIGS. 2 and 8, the anti-rotation ring 38 adopts its most downstream position relative to the nut 32, corresponding to a final position for coupling the shafts. It is held there by a ring 40 or an analogous retaining element, carried by the ring 38 and cooperating with a groove 42a opposite it, made on the inner surface of the nut 32 upstream of the first thread 34a.

In the final coupling position of the ring 38, the latter is thus retained axially with respect to the nut 32, via the ring 40, or any other system for stopping translation associated with the ring. In this position, a first rotational coupling device, as well as a second rotational coupling device, are provided, both in an active coupling configuration.

The first rotational coupling device consists of first rotational coupling members 44a made on the downstream end of the ring 38, and first complementary rotational coupling members 44b, provided on the upstream end of the first shaft 22. Here, these are preferably finger-notch assemblies, the fingers 44a preferably being provided on the ring 38, and the notches 44b on the first shaft 22, even if a reverse solution is possible. The notches 44b are also called first notches 44b.

The number of these finger-notch assemblies is preferably less than four, for example three, or two like in the drawings. In this case, the two fingers 44a are preferably diametrically opposite, just like their corresponding notches 44b on the upstream end of the first shaft 22, these notches opening axially upstream.

The fingers 44a, provided at the downstream end of the ring 38, protrude axially downstream and radially inward as shown in FIGS. 2, 5 and 8, or they protrude only axially downstream, as shown in the alternative of FIG. 6.

The second rotational coupling device consists of second rotational coupling members 46a made on the outer surface of the ring 38, and second complementary rotational coupling members 46b, provided on the inner surface of the nut 32. Here, these are preferably splines 46a, 46b cooperating with each other, in the form of two concentric annular rows of splines. Each annular row of splines 46a, 46b can be uninterrupted over 360°, or extend only over an angular sector smaller than 360°, or extend over several angular sectors circumferentially spaced apart from each other. The number of splines per annular row is high, for example more than twenty, thirty or forty. The number of splines is preferably the same for each of the two annular rows of splines, and this number is strictly greater than that of the number of notches and the number of fingers.

Each spline extends radially, in the conventional form of a tooth, and more precisely radially outward for the splines 46a, and radially inward for the splines 46b.

One of the particularities lies in the fact that the first splines 46a are axially spaced apart from the fingers 44a, upstream. Indeed, there is preferably no zone of axial overlapping between these elements 46a, 44a.

FIGS. 9 to 12 illustrate the method for mounting the coupling system 20 on the two shafts 22, 24.

First, the system 20 is placed on the first shaft 22, so that the nut 32 surrounds the upstream end of this shaft, then a tightening of this nut 32 is carried out via the first and second threads 34a, 34b. The goal of this tightening is to axially press the first shaft 22 against the second shaft 24, by pressing the downstream end of the nut against the second shaft 24. The tightening torque applied to the nut 32 corresponds to a minimum torque to ensure the desired coupling of the two shafts. This step is shown schematically in FIG. 9. During this step, the ring 38 is maintained in an inactive upstream position, called non-coupling position, where it is retained axially relative to the nut 32 via the ring 40 which cooperates with another groove 42b on the inner surface of the nut, arranged upstream of the groove 42a.

The next step is shown in FIGS. 10 and 11. It consists in rotating according to the axis X the ring 38 relative to the stationary nut 32, as well as translating it downstream. The rotation of the ring is used to place the fingers 44a in a position matching the notches 44b, after which an axial insertion of the fingers can be carried out in these same notches. This axial movement of the ring indeed leads to bringing the anti-rotation ring 38 into a provisional axial position relative to the nut, thus placing the first rotational coupling device 44a, 44b in its coupling configuration. However, the axial movement of the ring 38 is normally stopped by the lack of a matching position between the splines 46a, 46b, as shown in FIG. 11 in which it is shown that the first splines 46a are not aligned with inter-spline spaces on the other row of second splines 46b, and vice versa. As a result, in the provisional axial position of the ring 38, the second rotational coupling device 46a, 46b remains in a non-coupling configuration.

During this step, the rotation and the translational force on the ring 38 can be exerted simultaneously, in particular when these actions are carried out blindly in the mounting zone of the turbojet.

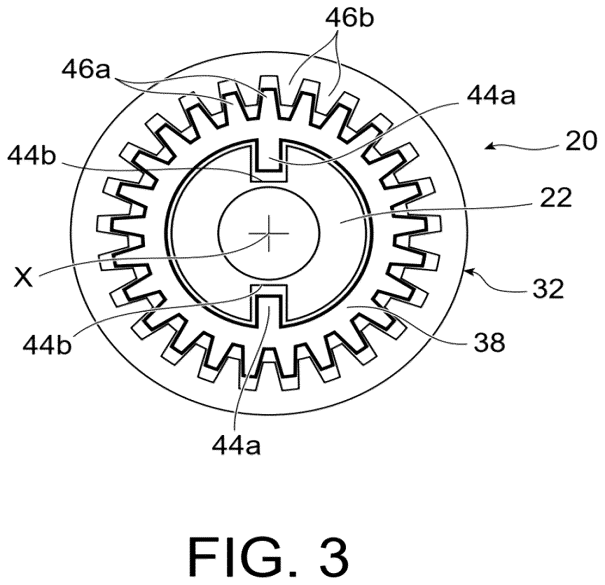

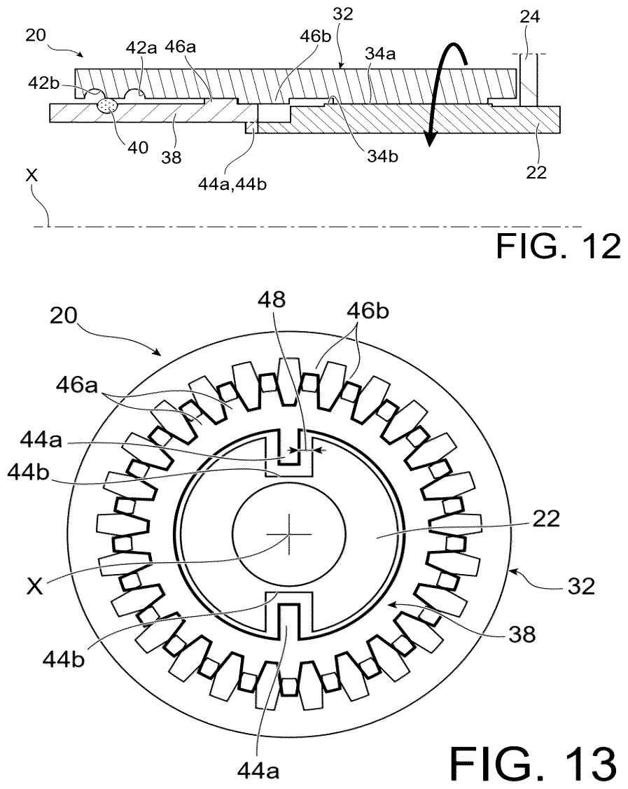

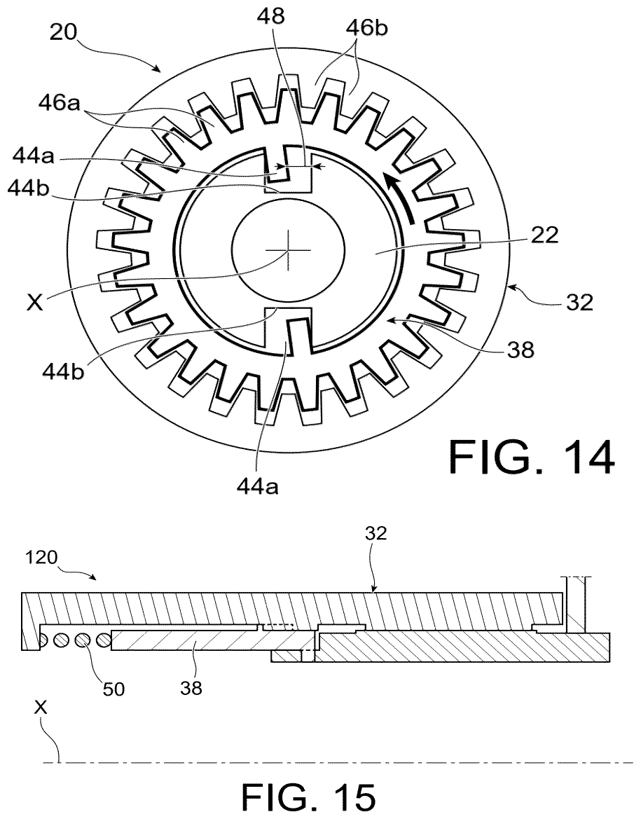

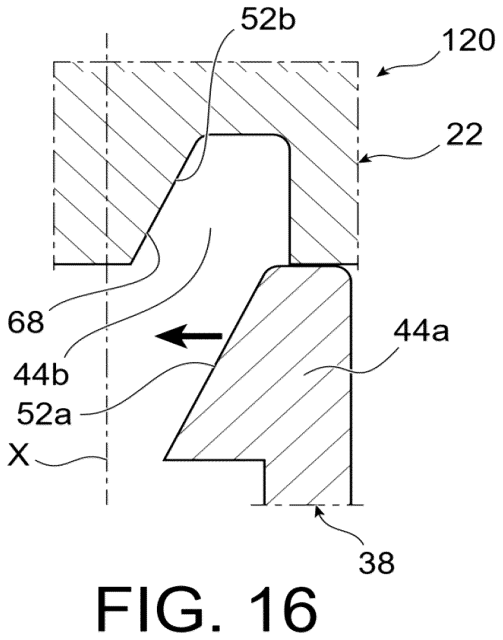

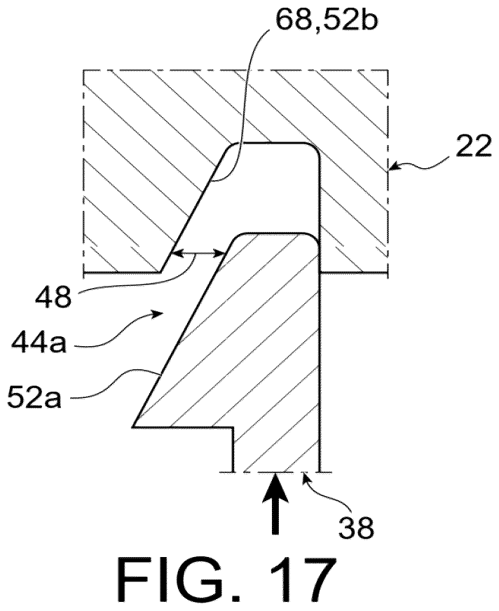

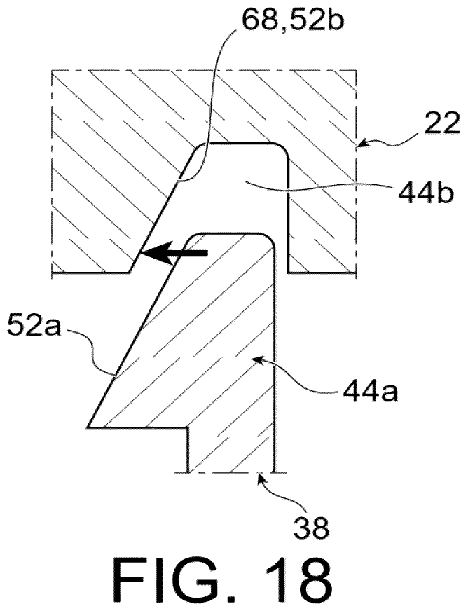

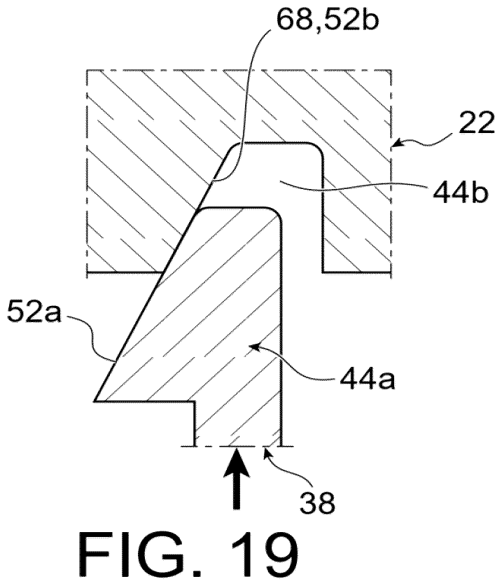

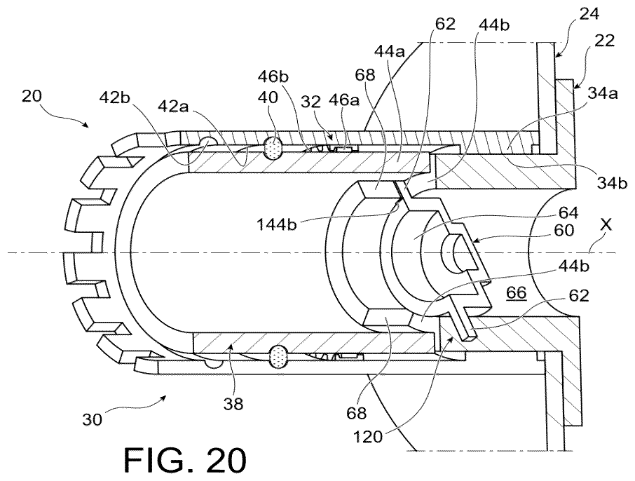

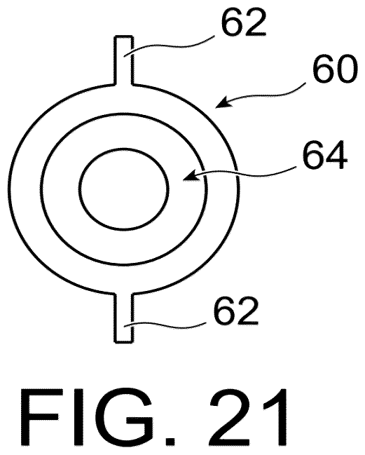

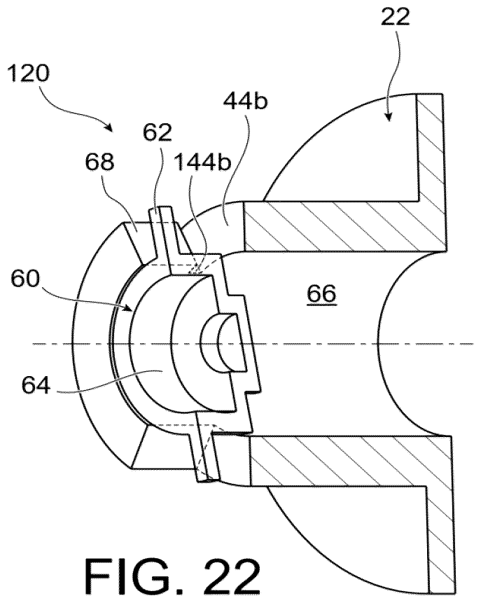

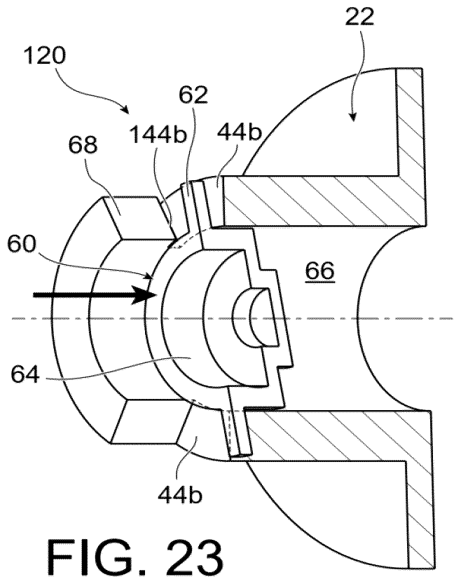

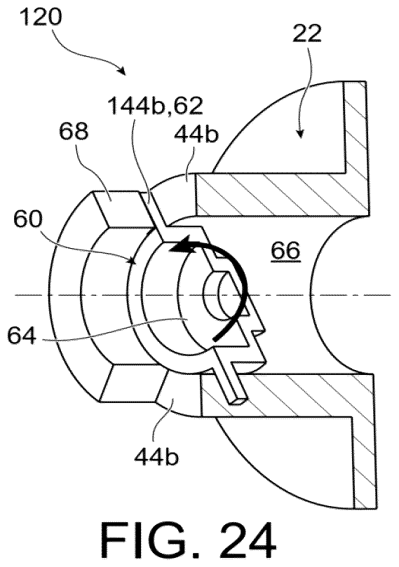

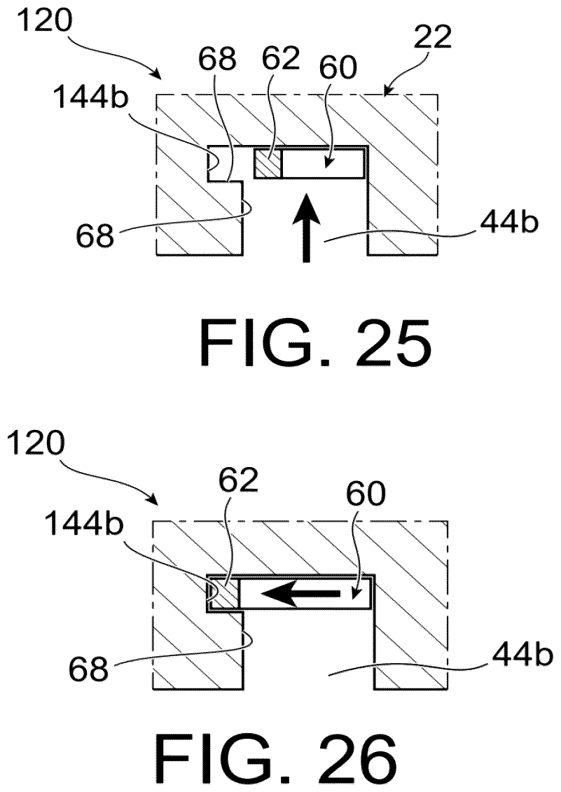

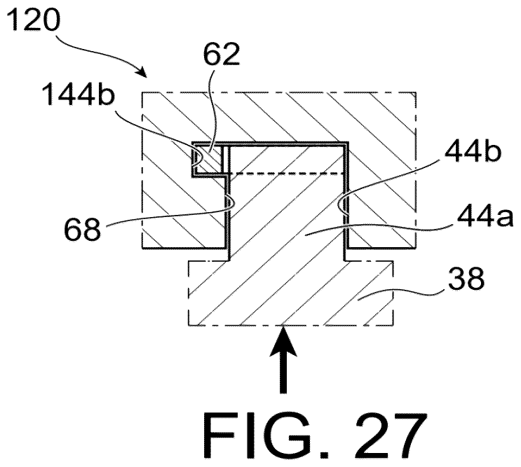

To achieve the desired matching position between the splines 46a, 46b, shown in particular in FIG. 3, another tightening of the nut 32 on the second shaft 22 is carried out. An over-torque is thus applied to the nut, with an intensity that remains moderate, until the desired matching position between the splines 46a, 46b is obtained. This step aimed at applying an over-torque to the nut 32 is shown schematically in FIG. 12.

Since the pitch of the splines is smaller than that of the notches, the rotation of the nut to be applied to allow the desired matching position between these splines, and the resulting over-torque, remain advantageously small.

Then, another axial movement of the ring 38 relative to the nut 32 is carried out, from its provisional axial position to its final coupling axial position, so as to make the splines 46a, 46b cooperate as shown in FIG. 2. Here also, it is noted that the rotation of the nut 32 and the application of the translational force to the ring 38 can be carried out simultaneously, in particular when these actions are carried out blindly in the mounting zone of the turbojet.

At the end of this step, the second rotational coupling device 46a, 46b is in its coupling configuration, due to the cooperation between the splines. Likewise, the first rotational coupling system 44a, 44b remains in its coupling configuration, after its fingers 44a have been further inserted into their respective notches 44b, after the additional axial movement of the ring 38 relative to the nut 32.

During this additional movement of the ring 38, the ring 40 is inserted into the groove 42a of the ring, thus ensuring its locking in translation. This allows to maintain the entire system 20 in a mounted state, ensuring the coupling in translation and in rotation of the two shafts 22, 24, without risk of loosening of the nut 32.

FIGS. 13 and 14 show an alternative, the design of which advantageously does not require the application of an over-torque to the nut, for the finalization of the mounting of the coupling system 20.

This alternative has many technical features in common with the embodiment shown in FIGS. 2 to 12, and moreover, in the drawings, the elements bearing the same numerical references correspond to identical or similar elements.

The alternative of FIGS. 13 and 14 shows the existence, in the provisional axial position of the ring 38, of a circumferential clearance 48 between each finger 44a and its corresponding notch 44b. This arrangement allows, by the clearance 48 being partly or totally used up, sufficient angular displacement of the ring 38 relative to the nut 32 remaining stationary, to allow the splines 46a, 46b to be placed in a matching position, still according to the circumferential direction. After such an operation, the coupling system 20 adopts a state as shown in FIG. 14. In this respect, it is noted that the circumferential direction, which extends around the X axis, also corresponds to the tangential direction.

As indicated above, the desired matching position between the splines 46a, 46b allows the axial displacement of the anti-rotation ring 38, from its provisional axial position to its final coupling axial position.

It is noted that a hybrid solution is also possible, wherein the placement of the splines 46a, 46b in a matching position is obtained on the one hand via the rotation of the ring 38 while using up the aforementioned clearance 48, and on the other hand via the application of a slight over-torque to the nut 32.

Another alternative is shown in FIG. 15, which provides elastic return means, like one or more springs 50 arranged axially between the nut 32 and the anti-rotation ring 38. The spring 50 allows to force the ring 38 axially downstream relative to the nut 32, and it is therefore capable of generating the axial forces required for the passage of the ring 38 from its most upstream position to its provisional axial position, then from this provisional axial position to its final coupling axial position.

This principle also allows to maintain the ring 38 in its final coupling axial position, so that the ring stop means are no longer necessarily required.

FIGS. 16 to 19 show various states of the coupling system 20 according to yet another alternative, wherein each finger 44a and its corresponding notch 44b have inclined circumferential stop surfaces, forming an angle with respect to the axial direction. In other words, each of these two surfaces 52a, 52b forms an angle having a non-zero value with the axial direction, parallel to the axis X.

The inclined circumferential stop surfaces 52a, 52b are shown in FIG. 16. They are parallel or substantially parallel, and respectively consist of a lateral side of the finger 44a, and a lateral side 68 of the notch 44b. The inclination of the circumferential stop surface 52b of the notch 44b is such that it flares out circumferentially axially in the upstream direction. Conversely, the inclination of the circumferential stop surface 52a of the finger 44a is such that the latter narrows circumferentially axially in the downstream direction.

The position of FIG. 16 corresponds to that of FIG. 9, in which the finger 44a is not yet in a position matching its associated notch 44b. When such a matching position is achieved after the rotation of the ring 38, under the effect of the operator or of the spring 50, the finger 44a is partially inserted into the notch 44b, as schematically shown in FIG. 17. The axial insertion is stopped by the stopping between the splines. The circumferential clearance 48 observed between the inclined circumferential stop surfaces 52a, 52b can then be used up, partially or totally by rotation of the ring 38, in order to place these same splines in a matching position (not shown in FIGS. 16 to 19). This step is shown schematically in FIG. 18. Then, when the splines are in a matching position, the ring 38 is axially moved to its final coupling axial position, under the effect of the spring 50. This position is reached when the circumferential stop surfaces 52a, 52b come in contact with one other as shown in FIG. 19, this contact being preferably surface contact.

Due to the inclination of the contact surfaces 52a, 52b, the stopped finger 44a, on the lateral side of the notch 44b, exerts an inclined force on the shaft 22 with a circumferential component. This component has a direction such that the finger 44a forces the second shaft 22 in a direction of rotation causing the nut 38 to tighten further on this shaft 22.

FIG. 20 shows the assembly 30 comprising the system 20 for coupling the two shafts 22, 24, but also a system 120 for locking a plug 60 in the first shaft 22. Indeed, the plug 60 is mounted at the upstream end of the first shaft 22, at the first rotational coupling device 44a, 44b, or near the latter. This plug 60 is used to seal, upstream, the hollow space 66 inside the shaft 22, centered on the axis X. This plug 60 may have to withstand significant loads, in particular pressure loads, which the locking system 120 must be able to resist.

In the embodiment of FIG. 20, the system 120 for locking the plug as well as the system 20 for coupling the two shafts are thus combined in the assembly 30, and they share common parts in order to have a compact overall design having lower mass and a reduced cost.

Still in reference to FIG. 20, the locking system 120 comprises the anti-rotation ring 38, which thus fulfills here the additional function of locking the plug 60. Consequently, in the rest of the description, this ring 38 will therefore be called locking ring.

The locking ring 38 is, as mentioned above, equipped with protruding elements formed by the fingers 44a. In a locking position of the ring 38, corresponding to its final coupling axial position described above, the fingers 44a are respectively inserted into first recesses of the shaft 22, corresponding to the first notches 44b. Other shapes could nevertheless be adopted for the protruding elements 44a and the first recesses 44b, without going beyond the scope of the invention.

One of the particularities lies here in the fact that the plug 60 comprises one or more retaining fingers 62, the number thereof preferably being identical to that of the first notches 44b, as well as their arrangement. It is therefore two retaining fingers 62 that are provided on a plug body 64, in a diametrically opposite manner. In this respect, it is noted that the body 64 of the plug has an outer diameter substantially equal to an inner diameter of the hollow 66 of the shaft 22, only a small mounting clearance preferably being retained. In addition, the retaining fingers 62 protrude radially outwards from this plug body 64.

Each of the retaining fingers 62 is inserted into a second recess of the shaft 22, this second recess taking the form of a second notch 144b opening circumferentially into one of the first notches 44b. Each second notch 144b can have a dimension much smaller than that of the first notch 44b into which it opens, for example taking the form of a simple indentation in the circumferential direction.

More precisely, each second circumferential notch 144b is made in one of the two lateral sides 68 of the first notch 44b into which it opens. In the preferred embodiment shown in FIG. 20, each second circumferential notch 144b (only one of the two notches 144b being visible in FIG. 20) is made at the axial bottom of its first associated notch 44b.

Thus, in the locking position of the ring 38 on the upstream end of the first shaft 22, each finger 44a circumferentially covers, at least partly, one of the second notches 144b housing a finger 62 for retaining the plug. More precisely, each finger 44a covers, in the circumferential direction, the bottom of one of the second notches 144b housing a retaining finger 62.

Via this overlap, each finger 44a is therefore followed with a second notch 144b in the circumferential direction, without these two elements necessarily being in contact with one other. In the event of circumferential play, the latter preferably remains sufficiently small to prevent the total extraction of the retaining finger 62 out of the second notch 144b.

FIG. 21 shows an axial view of the plug 60, the mounting method of which will now be described in reference to FIGS. 22 to 27.

Firstly, as visible in FIGS. 22, 23 and 25, a step of axially inserting the plug 60 into the hollow 66 of the first shaft 22 is carried out, so that each retaining finger 62 of the plug is inserted axially downstream into its first associated notch 44b of the shaft 22, until it reaches the axial bottom of this notch 44b.

Then, the plug 60 is rotated according to the axis X on which it is centered, so as to make each retaining finger 62 penetrate into its second associated notch 144b. The extent of the rotation can remain moderate, in correlation with the small depth of the second notch 144b. FIGS. 24 and 26 show the system 120 after this step has been carried out.

Finally, FIG. 27 illustrates the last step, corresponding to the axial movement of the locking ring 38 into its locking position. This leads to inserting each finger 44a into its first associated notch 44b of the shaft 22, until the finger 44a circumferentially covers, at least partly, the second notch 144b housing the retaining finger 62.

Of course, various modifications can be made by a person skilled in the art to the invention just described, only as non-limiting examples, and the scope of which is defined by the appended claims. In particular, the technical features of the various embodiments and their alternatives are interchangeable and/or can be combined.

1. A system for coupling two aircraft turbine engine parts,
comprising a nut for clamping the two parts together, the nut being provided with a nut thread intended to cooperate with a first part thread made on a first of the two parts, as well as an anti-rotation ring intended to limit/prevent the rotation of the nut relative to the first part,
wherein the anti-rotation ring comprises:
a first rotational coupling member intended to cooperate with a first complementary rotational coupling member provided on the first part, so as to form a first rotational coupling device;
a second rotational coupling member intended to cooperate with a second complementary rotational coupling member provided on the nut, so as to form a second rotational coupling device;
the coupling system being configured so that the anti-rotation ring;
can be placed in a provisional axial position relative to the nut, a position in which the first rotational coupling device is in a coupling configuration, while keeping the second rotational coupling device in a non-coupling configuration;
can be moved relative to the nut, from its provisional axial position to a final coupling axial position after rotation of the anti-rotation ring relative to the nut, a position in which the second rotational coupling device is in a coupling configuration, while keeping the first rotational coupling device in its coupling configuration.

2. The system according to claim 1, wherein the first rotational coupling device comprises one or more finger-notch assemblies, the number of these assemblies being less than six.

3. The system according to claim 1, wherein the second rotational coupling device is formed by splines.

4. The system according to claim 1, wherein in the provisional axial position of the anti-rotation ring, the first coupling member and the first complementary coupling member are intended to create between them a circumferential clearance allowing, by this clearance being used up, sufficient angular displacement of the anti-rotation ring to allow the second coupling member to be placed, according to the circumferential direction, in a position matching the second complementary coupling member, said matching position allowing the axial movement of the anti-rotation ring from its provisional axial position to its final coupling axial position.

5. The system according to claim 1, wherein the system comprises elastic return means arranged between the nut and the anti-rotation ring, so as to force the latter axially towards its final coupling axial position.

6. The system according to claim 1, wherein the first coupling member and the first complementary coupling member have inclined circumferential stop surfaces, forming an angle with respect to the axial direction.

7. The system according to claim 1, wherein the nut and the anti-rotation ring are concentric, the anti-rotation ring being inserted inside the nut.

8. An assembly for an aircraft turbine engine comprising two parts, as well as a system according to claim 1, coupling the two parts which are two turbine engine shafts.

9. An aircraft turbine engine, comprising at least one assembly according to claim 8.

10. A method for mounting a coupling system according to claim 1, on two aircraft turbine engine parts to be coupled, comprising the following steps:
carrying out a tightening of the nut on the first part, via the nut and first part threads, so as to axially press the first part against the second part;
bringing the anti-rotation ring into its provisional axial position relative to the nut, so as to place the first rotational coupling device in its coupling configuration, while keeping the second rotational coupling device in its non-coupling configuration;
moving the anti-rotation ring relative to the nut, from its provisional axial position to its final coupling axial position after rotation of the anti-rotation ring relative to the nut, so as to bring the second rotational coupling device into its coupling configuration, while keeping the first rotational coupling device in its coupling configuration.
